(19) United States
(12) Patent Application Publication
(10) Pub. No.: US 2026/0127889 A1
(43) Pub. Date: May 7, 2026

(54) SCENARIO REPRESENTATIONS FOR ONLINE SAMPLING OF SCENARIOS

(71) Applicant: QUALCOMM Incorporated, San Diego, CA (US)

(72) Inventors: Julia KABALAR, München (DE); Camille MAURICE, München (DE); Varun RAVI KUMAR, San Diego, CA (US); Kiran BANGALORE RAVI, Paris (FR); Senthil Kumar YOGAMANI, San Diego, CA (US)

(21) Appl. No.: 18/935,359

(22) Filed: Nov. 1, 2024

(51) Int. Cl. G06V 20/56; G01S 13/89; G01S 13/931; G06F 40/205; G06V 10/82; G06V 10/86

(52) U.S. Cl. CPC G06V 20/56; G01S 13/89; G01S 13/931; G06F 40/205; G06V 10/86; G01S 2013/9323; G06V 10/82

(57) ABSTRACT

Techniques and systems are provided for data collection. For instance a process can include detecting a set of objects in an environment based on an obtained set of multimodal data from a plurality of sensors; generating a scene graph based on the set of objects; receiving a query scene graph, wherein the query scene graph describes a scenario of interest; matching the scene graph with the query scene graph; and outputting the scene graph based on a successful match between the scene graph and the query scene graph.

### FIELD

The present disclosure generally relates to scenario representations. For example, aspects of the present disclosure are related to systems and techniques for providing scenario representations for online sampling of scenarios, for example, using a 3D semantic scene graph prediction network.

### BACKGROUND

Increasingly, systems and devices (e.g., autonomous vehicles, such as autonomous and semi-autonomous cars, drones, mobile robots, mobile devices, extended reality (XR) devices, and other suitable systems or devices) include multiple sensors to gather information about the environment, as well as processing systems to process the information gathered, such as for route planning, navigation, collision avoidance, etc. One example of such a system is an Advanced Driver Assistance System (ADAS) for a vehicle.

Sensor data, such as frames (e.g., images) captured from one or more sensors, such as camera(s), radio detection and ranging (RADAR), light detection and ranging (LIDAR), etc., may be gathered, transformed, and analyzed to detect objects (e.g., targets). Detected objects may be compared to known objects to help determine what object is being tracked. Generally, ADAS systems may include one or more machine learning (ML) models that may be trained to perform driving tasks, such as localization of an ego device, path planning, determining a response for vulnerable road users (e.g., pedestrians, bicyclists, etc.). In some cases, the quality of such ML models may depend at least in part on the quality of the data the ML model is trained on. In some cases, data that the ML models may be trained on may be collected from simulations and/or real-world driving. However, such data can be skewed towards common scenarios and may be missing rare (e.g., long-tail) and challenging scenarios. Techniques for a scenario representation for online sampling of scenarios may be useful for automating data collection strategies to help provide coverage for long-tail scenarios.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary presents certain concepts relating to one or more aspects relating to the mechanisms disclosed herein in a simplified form to precede the detailed description presented below.

In one illustrative example, an apparatus for data collection is provided. The apparatus includes at least one memory and at least one processor coupled to the at least one memory. The processor is configured to: detect a set of objects in an environment based on an obtained set of multimodal data from a plurality of sensors; generate a scene graph based on the set of objects; receive a query scene graph, wherein the query scene graph describes a scenario of interest; match the scene graph with the query scene graph; and output the scene graph based on a successful match between the scene graph and the query scene graph.

As another example, a method for data collection is provided. The method includes: detecting a set of objects in an environment based on an obtained set of multimodal data from a plurality of sensors; generating a scene graph based on the set of objects; receiving a query scene graph, wherein the query scene graph describes a scenario of interest; matching the scene graph with the query scene graph; and outputting the scene graph based on a successful match between the scene graph and the query scene graph.

In another example, a non-transitory computer-readable medium having stored thereon instructions is provided. The instructions, when executed by at least one processor, cause the at least one processor to: detect a set of objects in an environment based on an obtained set of multimodal data from a plurality of sensors; generate a scene graph based on the set of objects; receive a query scene graph, wherein the query scene graph describes a scenario of interest; match the scene graph with the query scene graph; and output the scene graph based on a successful match between the scene graph and the query scene graph.

For another example, an apparatus for data collection is provided. The apparatus includes: means for detecting a set of objects in an environment based on an obtained set of multimodal data from a plurality of sensors; means for generating a scene graph based on the set of objects; means for receiving a query scene graph, wherein the query scene graph describes a scenario of interest; means for matching the scene graph with the query scene graph; and means for outputting the scene graph based on a successful match between the scene graph and the query scene graph.

As another example, an apparatus for data collection is provided. The apparatus includes at least one memory and at least one processor coupled to the at least one memory. The processor is configured to: receive a description of a scenario of interest, wherein the description comprises a textual description of the scenario of interest; parse the description of the scenario of interest to generate a query scene graph based on the description of the scenario of interest; output the description of the scenario of interest for transmission to a vehicle; and output the query scene graph for transmission to the vehicle.

In another example, a method for data collection is provided. The method includes: receiving a description of a scenario of interest, wherein the description comprises a textual description of the scenario of interest; parsing the description of the scenario of interest to generate a query scene graph based on the description of the scenario of interest; outputting the description of the scenario of interest for transmission to a vehicle; and outputting the query scene graph for transmission to the vehicle.

For another example, a non-transitory computer-readable medium having stored thereon instructions is provided. The instructions, when executed by at least one processor, cause the at least one processor to: receive a description of a scenario of interest, wherein the description comprises a textual description of the scenario of interest; parse the description of the scenario of interest to generate a query scene graph based on the description of the scenario of interest; output the description of the scenario of interest for transmission to a vehicle; and output the query scene graph for transmission to the vehicle.

As another example, an apparatus for data collection is provided. The apparatus includes: means for receiving a description of a scenario of interest, wherein the description comprises a textual description of the scenario of interest; means for parsing the description of the scenario of interest to generate a query scene graph based on the description of the scenario of interest; means for outputting the description of the scenario of interest for transmission to a vehicle; and means for outputting the query scene graph for transmission to the vehicle.

In some aspects, one or more of the apparatuses described herein is, is part of, and/or includes a vehicle or a computing device or component of a vehicle (e.g., an autonomous vehicle), a camera, a mobile device (e.g., a mobile telephone or so-called “smart phone” or other mobile device), a wearable device, an extended reality device (e.g., a virtual reality (VR) device, an augmented reality (AR) device, or a mixed reality (MR) device), a personal computer, a laptop computer, a server computer, or other device. In some aspects, the apparatus(es) includes a camera or multiple cameras for capturing one or more images. In some aspects, the apparatus(es) further includes a display for displaying one or more images, notifications, and/or other displayable data. In some aspects, the apparatus(es) can include one or more sensors (e.g., one or more inertial measurement units (IMUs), such as one or more gyrometers, one or more accelerometers, any combination thereof, and/or other sensor).

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and embodiments, will become more apparent upon referring to the following specification, claims, and accompanying drawings.

### BRIEF DESCRIPTION OF THE DRAWINGS

Illustrative embodiments of the present application are described in detail below with reference to the following figures:

FIGS. 1A and 1B are block diagrams illustrating a vehicle suitable for implementing various techniques described herein, in accordance with aspects of the present disclosure;

FIG. 1C is a block diagram illustrating components of a vehicle suitable for implementing various techniques described herein, in accordance with aspects of the present disclosure;

FIG. 1D illustrates an example implementation of a system-on-a-chip (SOC), in accordance with some examples;

FIG. 2A illustrates an example of a fully connected neural network, in accordance with some examples;

FIG. 2B illustrates an example of a locally connected neural network, in accordance with some examples;

FIG. 2C illustrates an example of a convolutional neural network, in accordance with aspects of the present disclosure;

FIG. 2D illustrates a detailed example of a deep convolutional network (DCN) designed to recognize visual features from an image input from an image capturing device, in accordance with aspects of the present disclosure;

FIG. 3 is a block diagram illustrating an example of a deep convolutional network, in accordance with aspects of the present disclosure;

FIG. 4 illustrates a multimodal retrieval system using scenario representations for sampling scenarios, in accordance with aspects of the present disclosure;

FIG. 5 illustrates scene graph generation, in accordance with aspects of the present disclosure;

FIG. 6 is a flow diagram illustrating a process for data collection, in accordance with aspects of the present disclosure;

FIG. 7 is a flow diagram illustrating a process for data collection, in accordance with aspects of the present disclosure; and

FIG. 8 illustrates an example computing device architecture of an example computing device which can implement techniques described herein.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the spirit and scope of the application as set forth in the appended claims.

In some cases, an Advanced Driver Assistance System (ADAS) of a vehicle may use machine learning (ML) models to perform tasks to allow the vehicle to move through an environment. The quality of the ML models may vary based on the quality of data used to train the ML models. Using training data that accurately represents real-world scenarios may be useful for training. As an example, human factors, such as pedestrians or other vulnerable road users, can be challenging for ADAS systems as vulnerable road users can be behave in unpredictable ways, may be occluded, can appear in dense groups, etc. Additionally, vulnerable road users can appear in many different combinations with other objects and/or condition, such as in the presence of other vehicles, occluded by an object, in a crosswalk, along the road, etc. In some cases, it can be difficult to ensure a dataset includes a diverse set of scenarios for training. For example, data collected from simulation and/or real-world driving typically is heavily weighted towards highly safe scenarios (e.g., cruising on a highway, flowing traffic, etc.). More challenging scenarios tend to occur less often, leading to a long tail problem where rare, but challenging and/or dangerous scenarios may be underrepresented in the dataset. Manually directed data collection tends to struggle with capturing these infrequent events. Therefore, automated data selection strategies may be useful to efficiently collect data based on descriptions of scenarios of interest.

Systems, apparatuses, electronic devices, methods (also referred to as processes), and computer-readable media (collectively referred to herein as “systems and techniques”) are described herein for providing scenario representations for online sampling of scenarios. According to various aspects, data may be collected for training, for example, by a vehicle or apparatus. In some cases, the vehicle may sense an environment using multiple types of sensors to gather a set of multimodal data. As an example, the multimodal data may include camera data (e.g., an image), a light detection and ranging (LIDAR) point cloud, radio detection and ranging (RADAR) point cloud, etc.

Object detection may be performed on the set of multimodal data to detect, for example, a set of objects in the environment. In some cases, relationships between, for example, a first object and a second object may be determined. Examples of relationships can be a distance between the first object and the second object, an intent of the first object with respect to the second object, or other relationship.

Based on the detected objects, a scene graph may be generated. This scene graph may describe the scene of the environment as captured by the sensors. The scene graph may encode the objects and relationships between the objects. For example, the objects may be encoded as nodes in the scene graph, and the relationships may be encoded as edges between nodes.

In some cases, another device, such as a server, may store a dataset of the collected scenarios. In some cases, the dataset may be analyzed to determine scenarios of interest. These scenarios of interest may be scenarios which are relatively underrepresented in the dataset. The scenarios of interest may be described in a textual description. This textual description may be transmitted to the vehicle. The textual description may be parsed to generate a query scene graph. For example, the textual description may be parsed to detect objects and relationships between objects and the objects may be encoded as nodes and the relationships may be encoded as edges between nodes in the query scene graph. The query scene graph may also be transmitted to the vehicle.

The vehicle may receive the textual description and query scene graph. The vehicle may output the textual description, for example, using text to speech. The scene graph generated by the vehicle may be matched against the received query scene graph. If the scene graph matches the query scene graph, the scene graph may be output, for example, to the server where the scene graph may be saved to the dataset. In some cases, data associated with the scene (e.g., raw multimodal data) may also be output. If the scene graph does not match the query scene graph, then the scene graph may not be output to the server (e.g., not saved in the dataset). In some cases, the vehicles may receive multiple query scene graph. The vehicle may determine a driving context of the vehicle. This driving context may include a location of the vehicle, area where the vehicle is headed, etc. Based on the driving context, the vehicle may select a textual description of the scenario of interest for output.

Various aspects of the application will be described with respect to the figures.

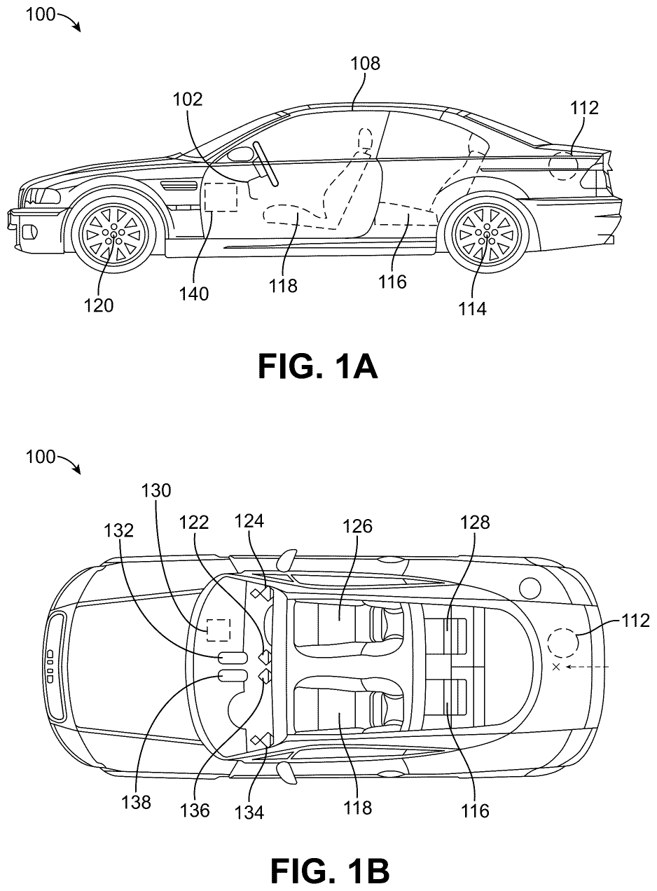

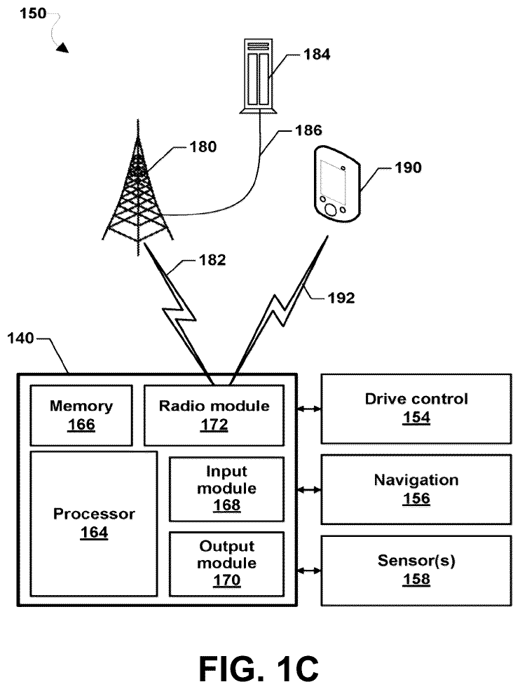

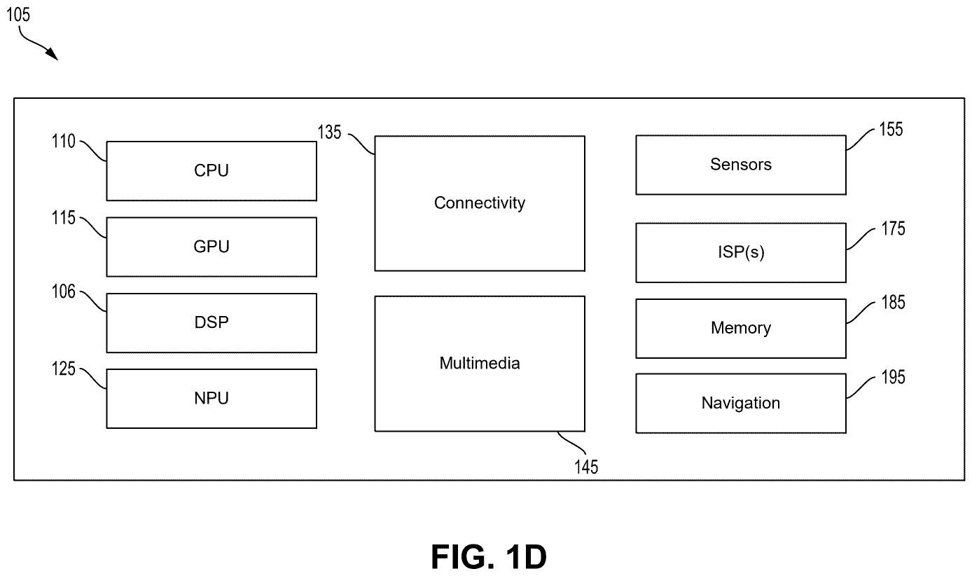

The systems and techniques described herein may be implemented by any type of system or device. One illustrative example of a system that can be used to implement the systems and techniques described herein is a vehicle (e.g., an autonomous or semi-autonomous vehicle) or a system or component (e.g., an ADAS, data collection system, or other system or component) of the vehicle. FIGS. 1A and 1B are diagrams illustrating an example vehicle 100 that may implement the systems and techniques described herein. With reference to FIGS. 1A and 1B, a vehicle 100 may include a control unit 140 and a plurality of sensors 102-138, including satellite geopositioning system receivers (e.g., sensors) 108, occupancy sensors 112, 116, 118, 126, 128, tire pressure sensors 114, 120, cameras 122, 136, microphones 124, 134, impact sensors 130, RADAR 132, and LIDAR 138. The plurality of sensors 102-138, disposed in or on the vehicle, may be used for various purposes, such as autonomous and semi-autonomous navigation and control, crash avoidance, position determination, etc., as well to provide sensor data regarding objects and people in or on the vehicle 100. The sensors 102-138 may include one or more of a wide variety of sensors capable of detecting a variety of information useful for navigation and collision avoidance. Each of the sensors 102-138 may be in wired or wireless communication with a control unit 140, as well as with each other. In particular, the sensors may include one or more cameras 122, 136 or other optical sensors or photo optic sensors. The sensors may further include other types of object detection and ranging sensors, such as RADAR 132, LIDAR 138, IR sensors, and ultrasonic sensors. The sensors may further include tire pressure sensors 114, 120, humidity sensors, temperature sensors, satellite geopositioning sensors 108, accelerometers, vibration sensors, gyroscopes, gravimeters, impact sensors 130, force meters, stress meters, strain sensors, fluid sensors, chemical sensors, gas content analyzers, pH sensors, radiation sensors, Geiger counters, neutron detectors, biological material sensors, microphones 124, 134, occupancy sensors 112, 116, 118, 126, 128, proximity sensors, and other sensors. Of note, while discussed in the context of a vehicle, aspects of the vehicle may be implemented as a data collection system for collecting information about the environment. The data collection system may be integrated with a vehicle, or logically separate from the vehicle (e.g., carried by (or affixed to) the vehicle).

The vehicle control unit 140 may be configured with processor-executable instructions to perform various aspects using information received from various sensors, particularly the cameras 122, 136, RADAR 132, and LIDAR 138. In some aspects, the control unit 140 may supplement the processing of camera images using distance and relative position information (e.g., relative bearing angle) that may be obtained from RADAR 132 and/or LIDAR 138 sensors. The control unit 140 may further be configured to control steering, breaking and speed of the vehicle 100 when operating in an autonomous or semi-autonomous mode using information regarding other vehicles determined using various aspects.

FIG. 1C is a component block diagram illustrating a system 150 of components and support systems suitable for implementing various aspects. With reference to FIGS. 1A, 1B, and 1C, a vehicle 100 may include a control unit 140, which may include various circuits and devices used to control the operation of the vehicle 100. In the example illustrated in FIG. 1C, the control unit 140 includes a processor 164, memory 166, an input module 168, an output module 170 and a radio module 172. The control unit 140 may be coupled to and configured to control drive control components 154, navigation components 156, and one or more sensors 158 of the vehicle 100.

The control unit 140 may include a processor 164 that may be configured with processor-executable instructions to control maneuvering, navigation, and/or other operations of the vehicle 100, including operations of various aspects. The processor 164 may be coupled to the memory 166. The control unit 140 may include the input module 168, the output module 170, and the radio module 172.

The radio module 172 may be configured for wireless communication. The radio module 172 may exchange signals 182 (e.g., command signals for controlling maneuvering, signals from navigation facilities, etc.) with a network node 180, and may provide the signals 182 to the processor 164 and/or the navigation components 156. In some aspects, the radio module 172 may enable the vehicle 100 to communicate with a wireless communication device 190 through a wireless communication link 92. The wireless communication link 92 may be a bidirectional or unidirectional communication link and may use one or more communication protocols.

The input module 168 may receive sensor data from one or more vehicle sensors 158 as well as electronic signals from other components, including the drive control components 154 and the navigation components 156. The output module 170 may be used to communicate with or activate various components of the vehicle 100, including the drive control components 154, the navigation components 156, and the sensor(s) 158.

The control unit 140 may be coupled to the drive control components 154 to control physical elements of the vehicle 100 related to maneuvering and navigation of the vehicle, such as the engine, motors, throttles, steering elements, other control elements, braking or deceleration elements, and the like. The drive control components 154 may also include components that control other devices of the vehicle, including environmental controls (e.g., air conditioning and heating), external and/or interior lighting, interior and/or exterior informational displays (which may include a display screen or other devices to display information), safety devices (e.g., haptic devices, audible alarms, etc.), and other similar devices.

The control unit 140 may be coupled to the navigation components 156 and may receive data from the navigation components 156. The control unit 140 may be configured to use such data to determine the present position and orientation of the vehicle 100, as well as an appropriate course toward a destination. In various aspects, the navigation components 156 may include or be coupled to a global navigation satellite system (GNSS) receiver system (e.g., one or more Global Positioning System (GPS) receivers) enabling the vehicle 100 to determine its current position using GNSS signals. Alternatively, or in addition, the navigation components 156 may include radio navigation receivers for receiving navigation beacons or other signals from radio nodes, such as Wi-Fi access points, cellular network sites, radio station, remote computing devices, other vehicles, etc. Through control of the drive control components 154, the processor 164 may control the vehicle 100 to navigate and maneuver. The processor 164 and/or the navigation components 156 may be configured to communicate with a server 184 on a network 186 (e.g., the Internet) using wireless signals 182 exchanged over a cellular data network via network node 180 to receive commands to control maneuvering, receive data useful in navigation, provide real-time position reports, and assess other data.

The control unit 140 may be coupled to one or more sensors 158. The sensor(s) 158 may include the sensors 102-138 as described and may be configured to provide a variety of data to the processor 164 and/or the navigation components 156. For example, the control unit 140 may aggregate and/or process data from the sensors 158 to produce information the navigation components 156 may use for localization. As a more specific example, the control unit 140 may process images from multiple camera sensors to generate a single semantically segmented image for the navigation components 156. As another example, the control unit 140 may generate a frame of fused point clouds from LIDAR and RADAR data for the navigation components 156.

While the control unit 140 is described as including separate components, in some aspects some or all of the components (e.g., the processor 164, the memory 166, the input module 168, the output module 170, and the radio module 172) may be integrated in a single device or module, such as a system-on-chip (SOC) processing device. Such an SOC processing device may be configured for use in vehicles and be configured, such as with processor-executable instructions executing in the processor 164, to perform operations of various aspects when installed into a vehicle.

FIG. 1D illustrates an example implementation of a system-on-a-chip (SOC) 105, which may include a central processing unit (CPU) 110 or a multi-core CPU, configured to perform one or more of the functions described herein. In some cases, the SOC 105 may be based on an ARM instruction set. In some cases, CPU 110 may be similar to processor 164. Parameters or variables (e.g., neural signals and synaptic weights), system parameters associated with a computational device (e.g., neural network with weights), delays, frequency bin information, task information, among other information may be stored in a memory block associated with a neural processing unit (NPU) 125, in a memory block associated with a CPU 110, in a memory block associated with a graphics processing unit (GPU) 115, in a memory block associated with a digital signal processor (DSP) 106, in a memory block 185, and/or may be distributed across multiple blocks. Instructions executed at the CPU 110 may be loaded from a program memory associated with the CPU 110 or may be loaded from a memory block 185.

The SOC 105 may also include additional processing blocks tailored to specific functions, such as a GPU 115, a DSP 106, a connectivity block 135, which may include fifth generation (5G) connectivity, fourth generation long term evolution (4G LTE) connectivity, Wi-Fi connectivity, USB connectivity, Bluetooth connectivity, and the like, and a multimedia processor 145 that may, for example, detect and recognize gestures. In one implementation, the NPU is implemented in the CPU 110, DSP 106, and/or GPU 115. The SOC 105 may also include a sensor processor 155, image signal processors (ISPs) 175, and/or navigation module 195, which may include a global positioning system. In some cases, the navigation module 195 may be similar to navigation components 156 and sensor processor 155 may accept input from, for example, one or more sensors 158. In some cases, the connectivity block 135 may be similar to the radio module 172.

In some cases, a vehicle, such as vehicle 100 in FIG. 1A and FIG. 1B, may collect information about the environment around the vehicle and stores the information for later use, such as for use as training data for ML models. In some cases, the information may also be processed by ML models, for example, to organize and/or categorize the information.

In some cases, sensor data, such as images captured by the image capture system, point clouds captured by LIDAR/RADAR sensors, etc., may be processed to use to train neural networks and/or machine learning (ML) systems. A neural network is an example of an ML system, and a neural network can include an input layer, one or more hidden layers, and an output layer. Data is provided from input nodes of the input layer, processing is performed by hidden nodes of the one or more hidden layers, and an output is produced through output nodes of the output layer. Deep learning networks typically include multiple hidden layers. Each layer of the neural network can include feature maps or activation maps that can include artificial neurons (or nodes). A feature map can include a filter, a kernel, or the like. The nodes can include one or more weights used to indicate an importance of the nodes of one or more of the layers. In some cases, a deep learning network can have a series of many hidden layers, with early layers being used to determine simple and low level characteristics of an input, and later layers building up a hierarchy of more complex and abstract characteristics.

A deep learning architecture may learn a hierarchy of features. If presented with visual data, for example, the first layer may learn to recognize relatively simple features, such as edges, in the input stream. In another example, if presented with auditory data, the first layer may learn to recognize spectral power in specific frequencies. The second layer, taking the output of the first layer as input, may learn to recognize combinations of features, such as simple shapes for visual data or combinations of sounds for auditory data. For instance, higher layers may learn to represent complex shapes in visual data or words in auditory data. Still higher layers may learn to recognize common visual objects or spoken phrases.

Deep learning architectures may perform especially well when applied to problems that have a natural hierarchical structure. For example, the classification of motorized vehicles may benefit from first learning to recognize wheels, windshields, and other features. These features may be combined at higher layers in different ways to recognize cars, trucks, and airplanes.

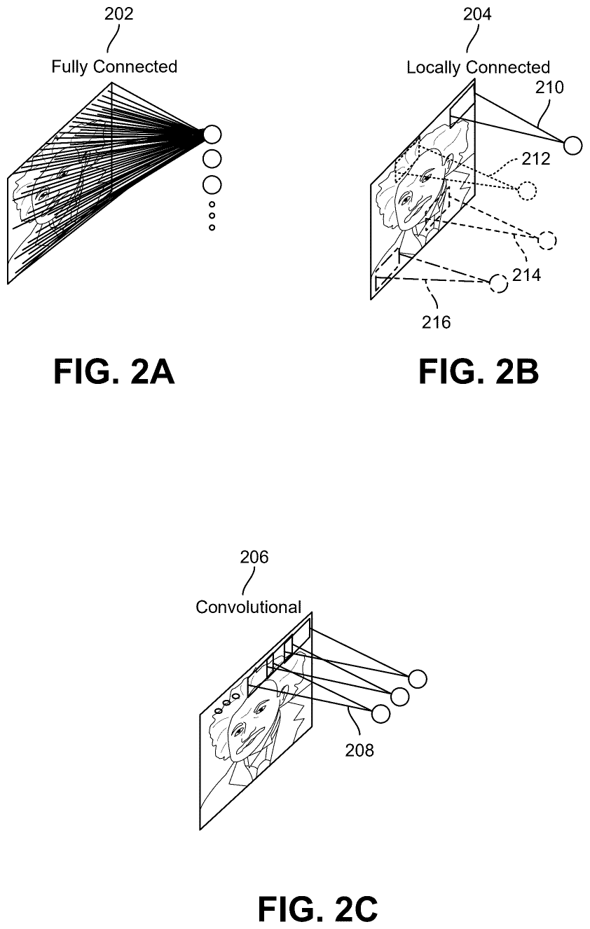

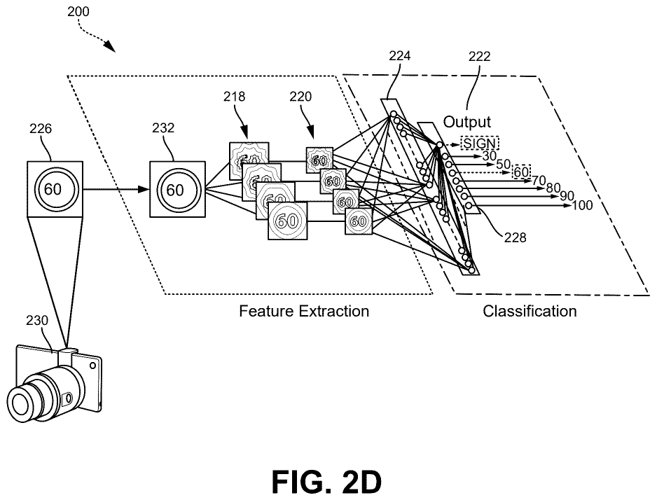

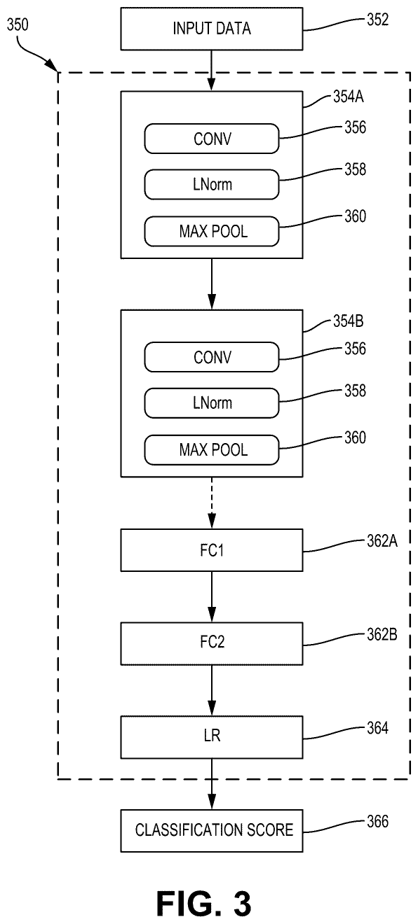

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input. The connections between layers of a neural network may be fully connected or locally connected. Various examples of neural network architectures are described below with respect to FIG. 2A-FIG. 3.

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input.

The connections between layers of a neural network may be fully connected or locally connected. FIG. 2A illustrates an example of a fully connected neural network 202. In a fully connected neural network 202, a neuron in a first layer may communicate its output to every neuron in a second layer, so that each neuron in the second layer will receive input from every neuron in the first layer. FIG. 2B illustrates an example of a locally connected neural network 204. In a locally connected neural network 204, a neuron in a first layer may be connected to a limited number of neurons in the second layer. More generally, a locally connected layer of the locally connected neural network 204 may be configured so that each neuron in a layer will have the same or a similar connectivity pattern, but with connections strengths that may have different values (e.g., 210, 212, 214, and 216). The locally connected connectivity pattern may give rise to spatially distinct receptive fields in a higher layer, because the higher layer neurons in a given region may receive inputs that are tuned through training to the properties of a restricted portion of the total input to the network.

One example of a locally connected neural network is a convolutional neural network. FIG. 2C illustrates an example of a convolutional neural network 206. The convolutional neural network 206 may be configured such that the connection strengths associated with the inputs for each neuron in the second layer are shared (e.g., 208). Convolutional neural networks may be well suited to problems in which the spatial location of inputs is meaningful. Convolutional neural network 206 may be used to perform one or more aspects of video compression and/or decompression, according to aspects of the present disclosure.

One type of convolutional neural network is a deep convolutional network (DCN). FIG. 2D illustrates a detailed example of a DCN 200 designed to recognize visual features from an image 226 input from an image capturing device 230. The DCN 200 of the current example may be trained to identify traffic signs and a number provided on the traffic sign. Of course, the DCN 200 may be trained for other tasks, such as identifying lane markings or identifying traffic lights.

The DCN 200 may be trained with supervised learning. During training, the DCN 200 may be presented with an image, such as the image 226 of a speed limit sign, and a forward pass may then be computed to produce an output 222. The DCN 200 may include a feature extraction section and a classification section. Upon receiving the image 226, a convolutional layer 232 may apply convolutional kernels (not shown) to the image 226 to generate a first set of feature maps 218. As an example, the convolutional kernel for the convolutional layer 232 may be a 5×5 kernel that generates 28×28 feature maps. In the present example, because four different feature maps are generated in the first set of feature maps 218, four different convolutional kernels were applied to the image 226 at the convolutional layer 232. The convolutional kernels may also be referred to as filters or convolutional filters.

The first set of feature maps 218 may be subsampled by a max pooling layer (not shown) to generate a second set of feature maps 220. The max pooling layer reduces the size of the first set of feature maps 218. That is, a size of the second set of feature maps 220, such as 14×14, is less than the size of the first set of feature maps 218, such as 28×28. The reduced size provides similar information to a subsequent layer while reducing memory consumption. The second set of feature maps 220 may be further convolved via one or more subsequent convolutional layers (not shown) to generate one or more subsequent sets of feature maps (not shown).

In the example of FIG. 2D, the second set of feature maps 220 is convolved to generate a first feature vector 224. Furthermore, the first feature vector 224 is further convolved to generate a second feature vector 228. Each feature of the second feature vector 228 may include a number that corresponds to a possible feature of the image 226, such as “sign,” “60,” and “100.” A softmax function (not shown) may convert the numbers in the second feature vector 228 to a probability. As such, an output 222 of the DCN 200 is a probability of the image 226 including one or more features.

In the present example, the probabilities in the output 222 for “sign” and “60” are higher than the probabilities of the others of the output 222, such as “30,” “40,” “50,” “70,” “80,” “90,” and “100”. Before training, the output 222 produced by the DCN 200 is likely to be incorrect. Thus, an error may be calculated between the output 222 and a target output. The target output is the ground truth of the image 226 (e.g., “sign” and “60”). The weights of the DCN 200 may then be adjusted so the output 222 of the DCN 200 is more closely aligned with the target output.

To adjust the weights, a learning algorithm may compute a gradient vector for the weights. The gradient may indicate an amount that an error would increase or decrease if the weight were adjusted. At the top layer, the gradient may correspond directly to the value of a weight connecting an activated neuron in the penultimate layer and a neuron in the output layer. In lower layers, the gradient may depend on the value of the weights and on the computed error gradients of the higher layers. The weights may then be adjusted to reduce the error. This manner of adjusting the weights may be referred to as “back propagation” as it involves a “backward pass” through the neural network.

In practice, the error gradient of weights may be calculated over a small number of examples, so that the calculated gradient approximates the true error gradient. This approximation method may be referred to as stochastic gradient descent. Stochastic gradient descent may be repeated until the achievable error rate of the entire system has stopped decreasing or until the error rate has reached a target level. After learning, the DCN may be presented with new images and a forward pass through the network may yield an output 222 that may be considered an inference or a prediction of the DCN.

Deep convolutional networks (DCNs) are networks of convolutional networks, configured with additional pooling and normalization layers. DCNs have achieved state-of-the-art performance on many tasks. DCNs can be trained using supervised learning in which both the input and output targets are known for many exemplars and are used to modify the weights of the network by use of gradient descent methods.

DCNs may be feed-forward networks. In addition, as described above, the connections from a neuron in a first layer of a DCN to a group of neurons in the next higher layer are shared across the neurons in the first layer. The feed-forward and shared connections of DCNs may be exploited for fast processing. The computational burden of a DCN may be much less, for example, than that of a similarly sized neural network that comprises recurrent or feedback connections.

The processing of each layer of a convolutional network may be considered a spatially invariant template or basis projection. If the input is first decomposed into multiple channels, such as the red, green, and blue channels of a color image, then the convolutional network trained on that input may be considered three-dimensional, with two spatial dimensions along the axes of the image and a third dimension capturing color information. The outputs of the convolutional connections may be considered to form a feature map in the subsequent layer, with each element of the feature map (e.g., feature maps 220) receiving input from a range of neurons in the previous layer (e.g., feature maps 218) and from each of the multiple channels. The values in the feature map may be further processed with a non-linearity, such as a rectification, max(0,x). Values from adjacent neurons may be further pooled, which corresponds to down sampling, and may provide additional local invariance and dimensionality reduction.

FIG. 3 is a block diagram illustrating an example of a deep convolutional network 350. The deep convolutional network 350 may include multiple different types of layers based on connectivity and weight sharing. As shown in FIG. 3, the deep convolutional network 350 includes the convolution blocks 354A, 354B. Each of the convolution blocks 354A, 354B may be configured with a convolution layer (CONV) 356, a normalization layer (LNorm) 358, and a max pooling layer (MAX POOL) 360. Of note, the layers illustrated with respect to convolution blocks 354A and 354B are examples of layers that may be included in a convolution layer and are not intended to be limiting and other types of layers may be included in any order.

The convolution layers 356 may include one or more convolutional filters, which may be applied to the input data 352 to generate a feature map. Although only two convolution blocks 354A, 354B are shown, the present disclosure is not so limiting, and instead, any number of convolution blocks (e.g., convolution blocks 354A, 354B) may be included in the deep convolutional network 350 according to design preference. The normalization layer 358 may normalize the output of the convolution filters. For example, the normalization layer 358 may provide whitening or lateral inhibition. The max pooling layer 360 may provide down sampling aggregation over space for local invariance and dimensionality reduction.

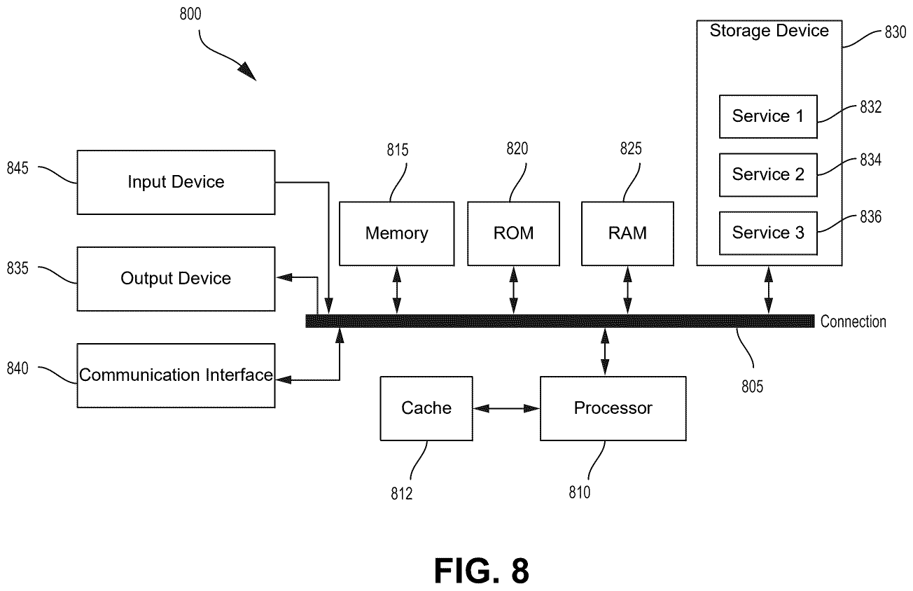

The parallel filter banks, for example, of a deep convolutional network may be loaded on a processor such as a CPU or GPU, or any other type of processor 810 discussed with respect to the computing system 800 of FIG. 8 to achieve high performance and low power consumption. In alternative aspects, the parallel filter banks may be loaded on a DSP or an ISP of the computing system 800 of FIG. 8. In addition, the deep convolutional network 350 may access other processing blocks that may be present on the computing system 800 of FIG. 8, such as sensor processor and navigation module, dedicated, respectively, to sensors and navigation.

The deep convolutional network 350 may also include one or more fully connected layers, such as layer 362A (labeled “FC1”) and layer 362B (labeled “FC2”). The deep convolutional network 350 may further include a logistic regression (LR) layer 364. Between each layer 356, 358, 360, 362A, 362B, 364 of the deep convolutional network 350 are weights (not shown) that are to be updated. The output of each of the layers (e.g., 356, 358, 360, 362A, 362B, 364) may serve as an input of a succeeding one of the layers (e.g., 356, 358, 360, 362A, 362B, 364) in the deep convolutional network 350 to learn hierarchical feature representations from input data 352 (e.g., images, audio, video, sensor data and/or other input data) supplied at the first of the convolution blocks 354A. The output of the deep convolutional network 350 is a classification score 366 for the input data 352. The classification score 366 may be a set of probabilities, where each probability is the probability of the input data including a feature from a set of features.

In some cases, one or more convolutional networks, such as a DCN, may be incorporated into more complex ML networks. As an example, as indicated above, the deep convolutional network 350 may output probabilities that an input data, such as an image, includes certain features. The deep convolutional network 350 may then be modified to extract (e.g., output) certain features. Additionally, DCNs may be added to extract other features as well. This set of DCNs may function as feature extractors to identify features in an image. In some cases, feature extractors may be used as a backbone for additional ML network components to perform further operations, such as localization, image segmentation, object detection, etc. In some cases, image segmentation and/or object detection may be used to identify and locate objects in the environment. For example, image segmentation may be used to segment the image by assigning labels to pixels of the image indicating what object in the environment the pixel represents.

In some cases, extracted features and images may be used to construct a bird's eye view (BEV) (e.g., a top-down view) multimodal feature map of an environment. Multimodal features may be generated based on data from multiple different types of sensors, such as an image sensor along with at least one other type of sensor, such as a LIDAR, RADAR, SODAR, SONAR, etc. sensor. Using different sensor types helps provide a more holistic understanding of the environment, increases robustness against failure and/or noise from a single sensor modality, and may help overcome occlusions. In some cases, a sensor type of a sensor may be based on how the sensor senses the environment. For example, two sensors which sense different parts of the electromagnetic spectrum may have different sensor types. Similarly, a sensor which senses reflection/refraction of projected light may have a different sensor type from another sensor which senses natural reflected/refracted light. The multimodal features may be transformed into BEV features to help provide a viewpoint invariant representation that encodes semantic information about the environment. Additionally, the BEV features may be normalized based on sensor configuration to help enable generalizability of the multimodal BEV features across systems with different sensors. Meta-features may refer to features of features (e.g., such as features of the features generated from sensor data).

For example, the BEV multimodal features may be used to generate a graph and meta-features may be features of the graph. The BEV multimodal features may be divided into a grid where each grid cell corresponds to a node in a feature graph being generated and the feature corresponding to that node may be the aggregate of all the pointwise features within the grid cell (e.g., features within the cell). A graph may be constructed where nodes of the graph represent grid cells and edges of the nodes may connect adjacent nodes based on connectivity. The multimodal features may be embedded in the nodes and edges of the graph. The graph encodes scenes representative of the environment as captured by the vehicles. For example, nodes of the graph may correspond to objects in the scene and the edges may capture associated representations among the objects.

In some cases, the graph-based representation for the BEV map may enable more efficient localization for matching sub-graphs against a global map graph as compared to a BEV based map. For example, a vehicle may generate a sub-graph (or set of BEV feature maps) which may be uploaded to a server which may match the sub-graphs to the global map graph to integrate the sub-graphs into the global map graph.

In some cases, the global map graph may be analyzed and/or processed. For example, the global map graph may be processed to identify data that may be used to train/further train ML models for an ADAS system. As another example, the global map graph may be analyzed and/or processed to identify scenarios in which more information should be collected for training. To identify data in the global map graph, a multimodal retrieval model may be used.

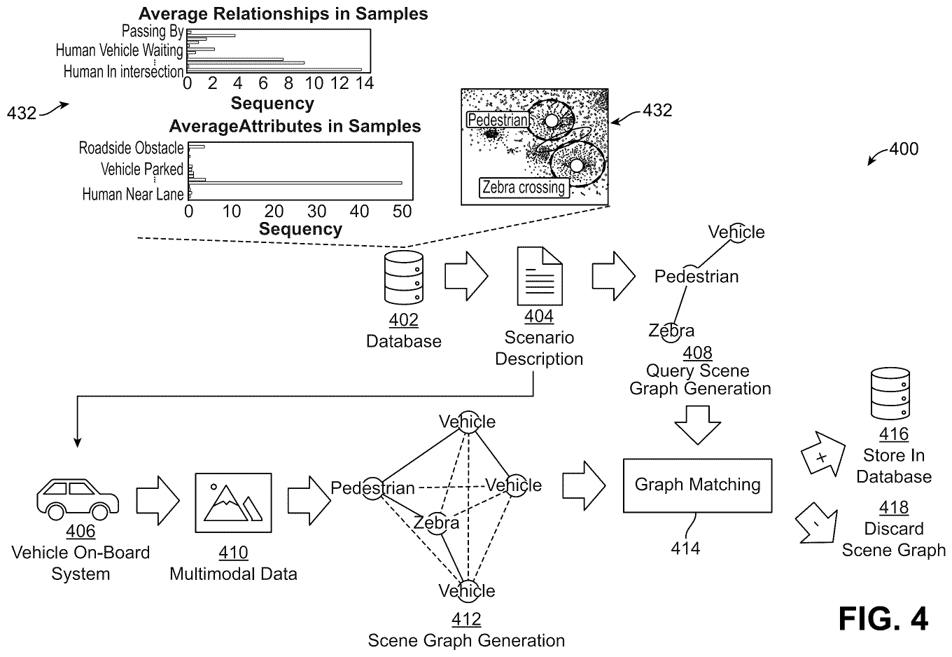

FIG. 4 illustrates a multimodal retrieval system 400 using scenario representations for sampling scenarios, in accordance with aspects of the present disclosure. The multimodal retrieval system 400 includes a database 402. The database 402 may include, for example, the global map graph describing scenarios (e.g., representations of environments) that have been collected. In some cases, the database 402 may be a coverage database including metadata distribution and feature embeddings along with the coverage/dataset distribution analysis tools. In some cases, feature embeddings 430 and dataset distribution 432 may be used to define scenarios for data collection. For example, as the global map is represented by a graph, nodes and edges (e.g., representing embedded features) may be analyzed (e.g., by automated tools or manual analysis) to determine which nodes have few or no overlap/edges. Additionally, dataset distribution 432 analysis may indicate which objects, distances, predicted intents, some combination thereof, etc. (e.g., based on node and edge attributes) may be under-represented in the global map. Based on this analysis scenarios that may have been captured or only captured infrequently may be determined for data collection. The scenarios for data collection may include those scenarios that are relatively underrepresented in the database 402.

In some cases, these determined scenarios for data collection may be described in textual form (e.g., a human-readable form), such as a scenario where “X pedestrian(s) is(are) waiting in front of zebra (distance<5 meters) nearby cars on a sunny day with high traffic within city.” The scenarios for data collection may be automatically communicated as scenario descriptions 404 to the vehicles 406 and/or on-board system, such as a data collection system. In some cases, the scenario descriptions 404 may be output to an operator of the vehicles 406, for example, as a scenario of interest based on the textual form. For example, the output may be through voice guidance using a text to speech system. In other cases, a route planning system may parse the textual form of the scenario of interest and determine a route based on the scenario of interest. For example, a route planning system with a real-time voice guidance system may provide instructions to the driver. The instructions may include verbal cues for data collection tasks based on the current driving route and scenario descriptions. Automated route planning may also optimize a driving path to try to encounter diverse scenarios and collect relevant data efficiently.

In some cases, a query scene graph may be generated 408. The query scene graph may be a graph of a scene based on the scenario descriptions 404. The query scene graph may include nodes, which may represent scene objects (e.g., road objects, objects in traffic, etc.), and edge information, which may describe relationships between nodes. The edge information may include spatial edge descriptors, such as distances between edges (e.g., between different objects in the scene), and semantic edge descriptors, which may describe behaviors of the object (e.g., predicted pedestrian intentions, predicated vehicle intentions, etc.). In some cases, the query scene graph may be in a graph format that is substantially similar to the one used for the global map graph in the database 402. A natural language processor may be used to parse the scenario descriptions 404 to detect subjects, objects, and relationships between the subject and object to generate a query scene graph. For example, subjects and objects may be mapped to nodes of the scene graph, and the relations may be encoded as spatial edge descriptors (e.g., distances, such as in from of zebra, <5 meters, nearby cars, etc.) or semantic edge descriptors (e.g., waiting). In some cases, the natural language processor may be a large language model (LLM)or low-rank adaptation (LoRA) of LLMs. In some cases, the query scene graph may be passed to the vehicles 406 and/or on-board systems.

In some cases, the vehicles 406 and/or on-board systems may include one or more of a wide variety of sensors capable of detecting a variety of information. Examples of the sensors may include cameras, RADAR, LIDAR, infrared (IR) sensors, ultrasonic sensors, pressure sensors, gyroscopic sensors, etc. These sensors may gather multimodal data 410. The multimodal data 410 may be used to generate a scene graph 412 describing a scene of the environment around the vehicles 406 and/or on-board systems. In some cases, in addition to object detection/segmentation, one or more ML models may analyze the multimodal data 410 to predict intents for objects around or on a road, such as pedestrians, bicyclists, other vehicles, etc. For example, a behavior of pedestrians or vehicles in a scene may be analyzed to infer what act the pedestrian or vehicle is going to perform. In some cases, the intent information may be an intent as between a first object (e.g., pedestrian) with respect to a second object (e.g., a vehicle). This intent information may be useful for determining whether objects may become a hazard. In some cases, the intent information may be determined using a human-object interaction detector, such as a vision transformer-based pose-conditioned self-loop graph (ViPLO) or graph parsing neural network.

In some cases, the scene graph 412 may be constructed in a format substantially similar format used for the query scene graph and the global map graph. The vehicles 406 and/or on-board systems generate the scene graph 412, for example, by performing entity segmentation for the multimodal data 410, build a 3D scene graph of the scene, perform semantic segmentation, and encode node and edge features with semantic context. In some cases, the scene graph may be incrementally built over time, for example, by receiving a previous scene graph and updating the previous scene graph based on current multimodal data 410.

The generated scene graph 412 may be matched 414 against the received query scene graph. In some cases, the generated scene graph 412 may be matched 414 against the received query scene graph using a similarity function such as a Jaccard similarity function

$$( {τ}_{j} = \frac{\vert A ⋂ B \vert}{\vert A ⋃ B \vert} )$$

or a Szymkiewicz-Simpson similarity function

$$( {τ}_{s} = \frac{\vert A ⋂ B \vert}{min ( \vert A \vert , \vert B \vert} ) .$$

In some cases, the similarity function may generate a similarity score where two graphs (e.g., graph A and graph B) have different sizes.

In some cases, the vehicles 406 and/or on-board systems may perform graph matching to determine if a sought-after scenario is currently being collected. If the query scene graph matches at least a portion of the scene graph, the scene graph may be stored 416 in the database 402 (e.g., uploaded/transmitted/sent to/output to/output for transmission to the database 402 for storage 416). If the scene graph does not match the query scene graph, the scene graph may not be stored (e.g., discarded 418) in the database 402. In either case, the scene graph may be incrementally updated at a next time step (e.g., at a future time). Thus, as a vehicle navigates through different environments, the scene graph may change to adapt to reflect new objects, relationships, and semantic contexts encountered along the route. This way, the data collection requirements remain relevant and accurate throughout a drive.

In some cases, context-aware data collection strategies that prioritize certain scenarios or objects based on the driving context may be used. The vehicle 406 and/or on-board system may receive multiple scenario descriptions 404 and the vehicle 406 and/or on-board system may select from among the multiple scenario descriptions 404 based on the driving context. In some cases, the driving context may be based on a location of the vehicle. For example, in an urban environment, the vehicles 406 and/or on-board system may prioritize collecting data on scenario descriptions 404 which include pedestrian interactions. In highway settings, the vehicles 406 and/or on-board system may focus on lane-keeping and vehicle following scenario descriptions 404. Context-aware strategies may help align data collection efforts with the specific requirements of each driving scenario.

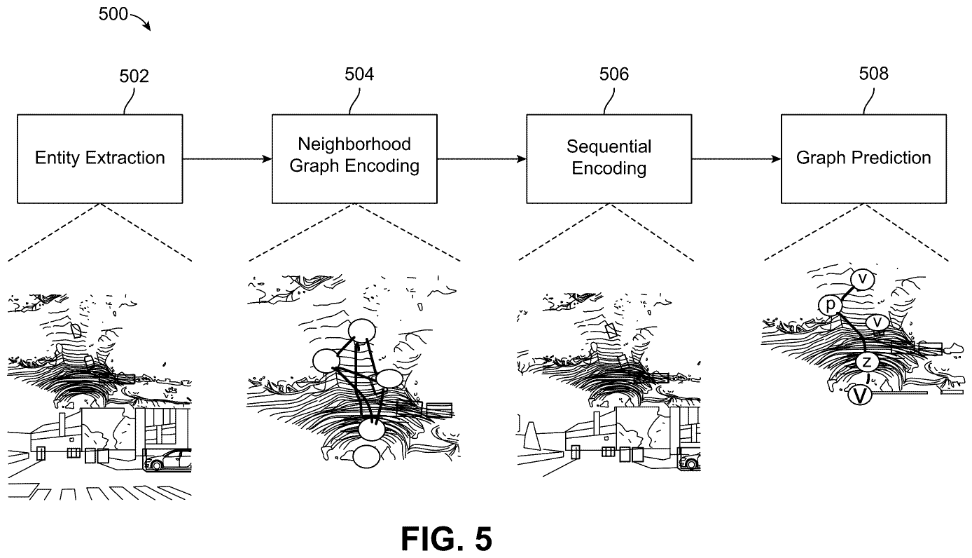

FIG. 5 illustrates scene graph generation 500, in accordance with aspects of the present disclosure. In some cases, scene graph generation 500 may be substantially similar to generating a scene graph 412 of FIG. 4. Scene graph generation may include entity extraction 502, neighborhood graph encoding 504, sequential encoding 506, and graph prediction 508. In some cases, the sensors of a vehicle (e.g., camera(s), LIDAR, RADAR, etc.), may sense the environment and provide data, such as one or more images or a point cloud. In some cases, multiple cameras may be used, for example, to provide depth information via stereo depth imaging. In some cases, LIDAR may transmit a beam of ultraviolet, visible, or near infrared light into an environment and detects reflections of the beam from objects in the environment. Based on an amount of time needed for the reflections to be detected, distances to objects in the environment may be determined and LIDAR points may be described based on the point's location on a width, height, and depth axes with respect to the LIDAR. Thus, the LIDAR data is three-dimensional data. RADAR may operate in a similar manner using a radio frequency beam. Features of the data, such as image features, LIDAR features, and/or RADAR features may be generated. The features of the data may be extracted using one or more feature extractors. These feature extractors may be ML based and the feature extractors may be used to identify certain features in the data. The extracted features may be passed into one or more object detectors or segmentation engines to identify (e.g., cluster) pixels/3D points corresponding to objects. In some cases, the object detectors and/or segmentation engines may be ML based. In some cases, other semantic properties of the detected objects may be generated, such as intent information for the detected objects.

For neighborhood graph encoding 504, a neighborhood graph (e.g., graph over a single frame) may be encoded based on the extracted features, detected objects, and other semantic properties. For example, detected objects may be encoded as nodes, distances between objects may be encoded as spatial edge descriptors, and semantic properties may be encoded as semantic edge descriptors.

In some cases, sequential encoding 506 may be performed over multiple data frames. In some cases, a data frame may be multimodal sensor data captured within a threshold amount of time of each other. As a part of sequential encoding 506, objects detected in multiple data frames may be associated and properties of the corresponding nodes updated. For example, where an object moves between frames, a property of the node corresponding with the object may be updated to indicate that the object is mobile. A vector indicating a direction and speed of the object may also be associated with the node. In some cases, objects that may not have been identified or misidentified in previous frames may also be updated. In some cases, the spatial edges and/or semantic edge relationships may be updated through message passing via the graph. Message passing may be a mechanism for graph neural networks that allows nodes in a graph to exchange information with their neighbors. This mechanism may be used for dynamic updates to the scene graph when new information is received to allow the scene representation to evolve over time based on changes in the environment to provide an updated view of the scene.

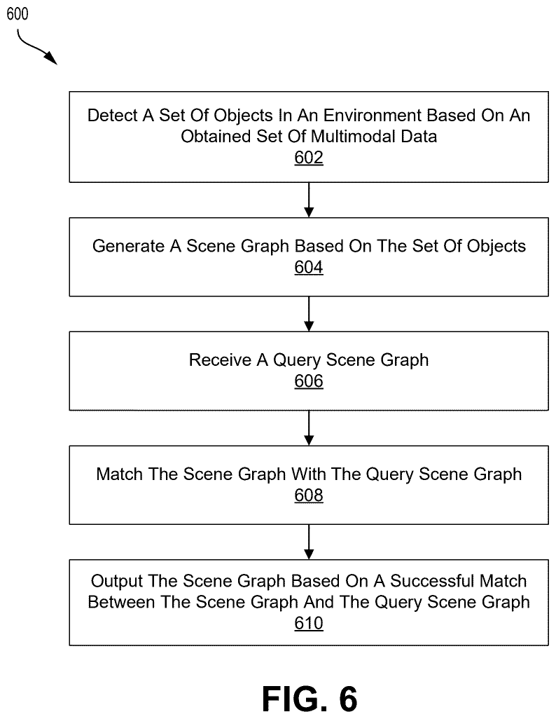

FIG. 6 is a flow diagram illustrating a process 600 for data collection, in accordance with aspects of the present disclosure. The process 600 may be performed by a computing device (or apparatus, e.g., vehicle 100 of FIG. 1A-1B, SOC 105 of FIG. 1D, image capturing device 230 of FIG. 2D, vehicle 406 of FIG. 4, computing system 800 of FIG. 8, etc.) or a component (e.g., a chipset, codec, vehicle control unit 140 of FIG. 1A-1B, processor 164 of FIG. 1C, CPU 110, GPU 115, DSP 106, NPU 125 of FIG. 1D, processor 810 of FIG. 8, etc.) of the computing device. The computing device may be a mobile device (e.g., a mobile phone), a network-connected wearable such as a watch, an extended reality (XR) device such as a virtual reality (VR) device or augmented reality (AR) device, a vehicle or component or system of a vehicle, or other type of computing device. The operations of the process 600 may be implemented as software components that are executed and run on one or more processors.

At block 602, the computing device (or component thereof) may detect a set of objects in an environment based on an obtained set of multimodal data (e.g., multimodal data 410 of FIG. 4) from a plurality of sensors (e.g., sensors 102-138 of FIGS. 1A and 1B). In some examples, the obtained set of multimodal data includes at least one of an image, a light detection and ranging (LIDAR) data, or radio detection and ranging (RADAR) data. In some cases, the computing device (or component thereof) may receive a first description of a first scenario of interest, wherein the first description comprises a textual description of the first scenario of interest; and output the textual description of the first scenario of interest. For example, the output may be through voice guidance using a text to speech system. In some examples, the computing device (or component thereof) may receive a second description of a second scenario of interest; determine a driving context of the apparatus; and determine to output the second description of the second scenario of interest instead of the first description of the first scenario of interest based on the driving context of the apparatus. In some cases, the driving context is based on a location of the computing device. For example, where the driving context is based on a location of the vehicle, the vehicles and/or on-board system may prioritize collecting data based on the location of the vehicle. For example, nodes of the graph may correspond to objects in the scene and the edges may capture associated representations among the objects. In some examples, the computing device (or component thereof) may encode the first object as a first node in the scene graph; encode the second object as a second node in the scene graph; and encode the relationship as an edge between the first node and the second node.

At block 604, the computing device (or component thereof) may generate a scene graph (e.g., scene graph 412 of FIG. 4) based on the set of objects. In some cases, the scene graph may describe a scene of the environment around a vehicle and/or on-board systems. In some example, the computing device (or component thereof) may determine a relationship between a first object in the set of objects and a second object in the set of objects; and encode the relationship in the scene graph. In some examples, the relationship comprises at least one of a distance between the first object and the second object, or an intent of the first object with respect to the second object. In some cases, the computing device (or component thereof) may detect a second set of objects in the environment based on an obtained second set of multimodal data; and update the scene graph based on the second set of objects.

At block 606, the computing device (or component thereof) may receive a query scene graph. In some cases, the query scene graph describes a scenario of interest. For example, the query scene graph may be a graph of a scene based on a scenario description.

At block 608, the computing device (or component thereof) may match (e.g., matched 414 of FIG. 4) the scene graph with the query scene graph. For example, graph matching may be performed to determine if a sought-after scenario is currently being collected by the vehicle and/or on-board systems.

At block 610, the computing device (or component thereof) may output the scene graph based on a successful match between the scene graph and the query scene graph.

In some examples, the processes described herein (e.g., process 600 and/or other process described herein) may be performed by the vehicle 100 of FIG. 1A.

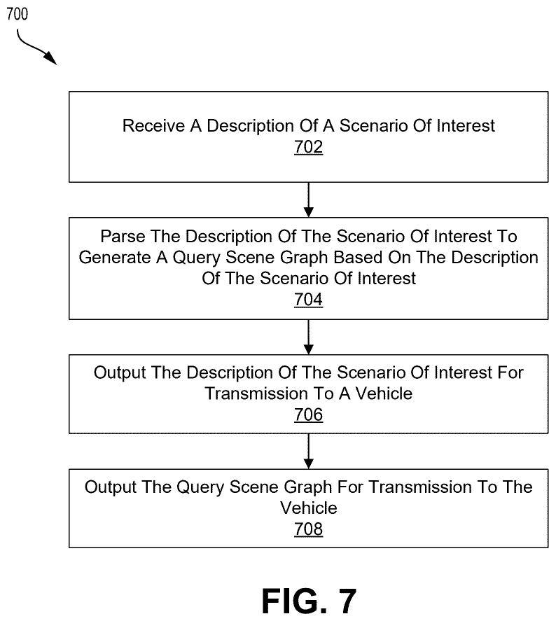

FIG. 7 is a flow diagram illustrating a process 700 for data collection, in accordance with aspects of the present disclosure. The process 700 may be performed by a computing device (or apparatus, e.g., server 184 of FIG. 1C, SOC 105 of FIG. 1D, computing system 800 of FIG. 8, etc.) or a component (e.g., a chipset, codec, CPU 110, GPU 115, DSP 106, NPU 125 of FIG. 1D, processor 810 of FIG. 8, etc.) of the computing device. The computing device may be a network connected computer, server device, server cluster, mobile device (e.g., a mobile phone), a network-connected wearable such as a watch, an extended reality (XR) device such as a virtual reality (VR) device or augmented reality (AR) device, a vehicle or component or system of a vehicle, or other type of computing device. The operations of the process 700 may be implemented as software components that are executed and run on one or more processors.

At block 702, the computing device (or component thereof) may receive a description of a scenario of interest (e.g., scenario descriptions 404 of FIG. 4). In some cases, the description comprises a textual description of the scenario of interest. In some examples, the description of a scenario of interest is generated based on scenarios which are underrepresented in the dataset. In some cases, the description of the scenario includes a first object, a second object, and a relationship between the first object and second object. In some examples, the computing device (or component thereof) may encode the first object as a first node in the query scene graph; encode the second object as a second node in the query scene graph; and encode the relationship as an edge between the first node and the second node.

At block 704, the computing device (or component thereof) may parse the description of the scenario of interest to generate a query scene graph based on the description of the scenario of interest. For example, a natural language processor may be used to parse the scenario descriptions to detect subjects, objects, and relationships between the subject and object to generate the query scene graph.

At block 706, the computing device (or component thereof) may output the description of the scenario of interest for transmission to a vehicle. For example, the scenarios for data collection may be automatically communicated as scenario descriptions to the vehicles and/or on-board system.

At block 708, the computing device (or component thereof) may output the query scene graph for transmission to the vehicle. For example, the query scene graph may be passed to the vehicles and/or on-board systems. In some cases, the computing device (or component thereof) may receive a scene graph matching the query scene graph from the vehicle; and store the scene graph in a dataset (e.g., database 402 of FIG. 4). For example, vehicles and/or on-board systems may perform graph matching to determine if a sought-after scenario is currently being collected, and if the query scene graph matches at least a portion of the scene graph, the scene graph may be uploaded and stored in the database.

In some examples, the techniques or processes described herein may be performed by a computing device, an apparatus, and/or any other computing device. In some cases, the computing device or apparatus may include a processor, microprocessor, microcomputer, or other component of a device that is configured to carry out the steps of processes described herein. In some examples, the computing device or apparatus may include a camera configured to capture video data (e.g., a video sequence) including video frames. For example, the computing device may include a camera device, which may or may not include a video codec. As another example, the computing device may include a mobile device with a camera (e.g., a camera device such as a digital camera, an IP camera or the like, a mobile phone or tablet including a camera, or other type of device with a camera). In some cases, the computing device may include a display for displaying images. In some examples, a camera or other capture device that captures the video data is separate from the computing device, in which case the computing device receives the captured video data. The computing device may further include a network interface, transceiver, and/or transmitter configured to communicate the video data. The network interface, transceiver, and/or transmitter may be configured to communicate Internet Protocol (IP) based data or other network data.

The processes described herein can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

In some cases, the devices or apparatuses configured to perform the operations of the process 600, 700, and/or other processes described herein may include a processor, microprocessor, micro-computer, or other component of a device that is configured to carry out the steps of the process 600, 700, and/or other process. In some examples, such devices or apparatuses may include one or more sensors configured to capture image data and/or other sensor measurements. In some examples, such computing device or apparatus may include one or more sensors and/or a camera configured to capture one or more images or videos. In some cases, such device or apparatus may include a display for displaying images. In some examples, the one or more sensors and/or camera are separate from the device or apparatus, in which case the device or apparatus receives the sensed data. Such device or apparatus may further include a network interface configured to communicate data.

The components of the device or apparatus configured to carry out one or more operations of the process 600, 700, and/or other processes described herein can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein. The computing device may further include a display (as an example of the output device or in addition to the output device), a network interface configured to communicate and/or receive the data, any combination thereof, and/or other component(s). The network interface may be configured to communicate and/or receive Internet Protocol (IP) based data or other type of data.

The process 600 and process 700 are illustrated as a logical flow diagrams, the operations of which represent sequences of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the processes described herein (e.g., the process 600, 700, and/or other processes) may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program including a plurality of instructions executable by one or more processors. The computer-readable or machine-readable storage medium may be non-transitory.

Additionally, the processes described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 8 is a diagram illustrating an example of a system for implementing certain aspects of the present technology. In particular, FIG. 8 illustrates an example of computing system 800, which may be for example any computing device making up internal computing system, a remote computing system, a camera, or any component thereof in which the components of the system are in communication with each other using connection 805. Connection 805 may be a physical connection using a bus, or a direct connection into processor 810, such as in a chipset architecture. Connection 805 may also be a virtual connection, networked connection, or logical connection.

In some embodiments, computing system 800 is a distributed system in which the functions described in this disclosure may be distributed within a datacenter, multiple data centers, a peer network, etc. In some embodiments, one or more of the described system components represents many such components each performing some or all of the function for which the component is described. In some embodiments, the components may be physical or virtual devices.

Example system 800 includes at least one processing unit (CPU or processor) 810 and connection 805 that communicatively couples various system components including system memory 815, such as read-only memory (ROM) 820 and random access memory (RAM) 825 to processor 810. Computing system 800 may include a cache 812 of high-speed memory connected directly with, in close proximity to, or integrated as part of processor 810.

Processor 810 may include any general purpose processor and a hardware service or software service, such as services 832, 834, and 836 stored in storage device 830, configured to control processor 810 as well as a special-purpose processor where software instructions are incorporated into the actual processor design. Processor 810 may essentially be a completely self-contained computing system, containing multiple cores or processors, a bus, memory controller, cache, etc. A multi-core processor may be symmetric or asymmetric.

To enable user interaction, computing system 800 includes an input device 845, which may represent any number of input mechanisms, such as a microphone for speech, a touch-sensitive screen for gesture or graphical input, keyboard, mouse, motion input, speech, etc. Computing system 800 may also include output device 835, which may be one or more of a number of output mechanisms. In some instances, multimodal systems may enable a user to provide multiple types of input/output to communicate with computing system 800.

Computing system 800 may include communications interface 840, which may generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 840 may also include one or more Global Navigation Satellite System (GNSS) receivers or transceivers that are used to determine a location of the computing system 800 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 830 may be a non-volatile and/or non-transitory and/or computer-readable memory device and may be a hard disk or other types of computer readable media which may store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L #) cache), resistive random-access memory (RRAM/ReRAM), phase change memory (PCM), spin transfer torque RAM (STT-RAM), another memory chip or cartridge, and/or a combination thereof.

The storage device 830 may include software services, servers, services, etc., that when the code that defines such software is executed by the processor 810, it causes the system to perform a function. In some embodiments, a hardware service that performs a particular function may include the software component stored in a computer-readable medium in connection with the necessary hardware components, such as processor 810, connection 805, output device 835, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data may be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Specific details are provided in the description above to provide a thorough understanding of the embodiments and examples provided herein, but those skilled in the art will recognize that the application is not limited thereto. Thus, while illustrative embodiments of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, embodiments may be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate embodiments, the methods may be performed in a different order than that described.

For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual embodiments may be described above as a process or method which is depicted as a flowchart, a flow diagram, a data flow diagram, a structure diagram, or a block diagram. Although a flowchart may describe the operations as a sequential process, many of the operations may be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination may correspond to a return of the function to the calling function or the main function.

Processes and methods according to the above-described examples may be implemented using computer-executable instructions that are stored or otherwise available from computer-readable media. Such instructions may include, for example, instructions and data which cause or otherwise configure a general purpose computer, special purpose computer, or a processing device to perform a certain function or group of functions. Portions of computer resources used may be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some embodiments the computer-readable storage devices, mediums, and memories may include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and may take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also may be embodied in peripherals or add-in cards. Such functionality may also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that may be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein may be replaced with less than or equal to (“≤”) and greater than or equal to (“≥”) symbols, respectively, without departing from the scope of this description.

Where components are described as being “configured to” perform certain operations, such configuration may be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

Illustrative aspects of the disclosure include:

### Aspect 1

An apparatus for data collection, comprising: at least one memory; and at least one processor coupled to the at least one memory and configured to: detect a set of objects in an environment based on an obtained set of multimodal data from a plurality of sensors; generate a scene graph based on the set of objects; receive a query scene graph, wherein the query scene graph describes a scenario of interest; match the scene graph with the query scene graph; and output the scene graph based on a successful match between the scene graph and the query scene graph.

### Aspect 2

The apparatus of Aspect 1, wherein the at least one processor is configured to: receive a first description of a first scenario of interest, wherein the first description comprises a textual description of the first scenario of interest; and output the textual description of the first scenario of interest.

### Aspect 3

The apparatus of Aspect 2, wherein the at least one processor is configured to: receive a second description of a second scenario of interest; determine a driving context of the apparatus; and determine to output the second description of the second scenario of interest instead of the first description of the first scenario of interest based on the driving context of the apparatus.

### Aspect 4

The apparatus of Aspect 3, wherein the driving context is based on a location of the apparatus.

### Aspect 5

The apparatus of any of Aspects 1-4, wherein the at least one processor is configured to: determine a relationship between a first object in the set of objects and a second object in the set of objects; and encode the relationship in the scene graph.

### Aspect 6

The apparatus of Aspect 5, wherein the relationship comprises at least one of a distance between the first object and the second object, or an intent of the first object with respect to the second object.

### Aspect 7

The apparatus of any of Aspects 5-6, wherein the at least one processor is configured to: encode the first object as a first node in the scene graph; encode the second object as a second node in the scene graph; and encode the relationship as an edge between the first node and the second node.

### Aspect 8

The apparatus of any of Aspects 1-7, wherein the obtained set of multimodal data includes at least one of an image, a light detection and ranging (LIDAR) data, or radio detection and ranging (RADAR) data.

### Aspect 9

The apparatus of any of Aspects 1-8, wherein the at least one processor is configured to: detect a second set of objects in the environment based on an obtained second set of multimodal data; and update the scene graph based on the second set of objects.

### Aspect 10

An apparatus for data collection, comprising: at least one memory; and at least one processor coupled to the at least one memory and configured to: receive a description of a scenario of interest, wherein the description comprises a textual description of the scenario of interest; parse the description of the scenario of interest to generate a query scene graph based on the description of the scenario of interest; output the description of the scenario of interest for transmission to a vehicle; and output the query scene graph for transmission to the vehicle.

### Aspect 11

The apparatus of Aspect 10, wherein the at least one processor is further configured to: receive a scene graph matching the query scene graph from the vehicle; and store the scene graph in a dataset.

### Aspect 12

The apparatus of Aspect 11, wherein the description of a scenario of interest is generated based on scenarios which are underrepresented in the dataset.

### Aspect 13

The apparatus of any of Aspects 10-12, wherein the description of the scenario includes a first object, a second object, and a relationship between the first object and second object, and wherein the at least one processor is further configured to: encode the first object as a first node in the query scene graph; encode the second object as a second node in the query scene graph; and encode the relationship as an edge between the first node and the second node.

### Aspect 14

A method for data collection, comprising: detecting a set of objects in an environment based on an obtained set of multimodal data from a plurality of sensors; generating a scene graph based on the set of objects; receiving a query scene graph, wherein the query scene graph describes a scenario of interest; matching the scene graph with the query scene graph; and outputting the scene graph based on a successful match between the scene graph and the query scene graph.

### Aspect 15

The method of Aspect 14, further comprising: receiving a first description of a first scenario of interest, wherein the first description comprises a textual description of the first scenario of interest; and outputting the textual description of the first scenario of interest.

### Aspect 16

The method of Aspect 15, further comprising: receiving a second description of a second scenario of interest; determining a driving context of a vehicle; and determining to output the second description of the second scenario of interest instead of the first description of the first scenario of interest based on the driving context of the vehicle.

### Aspect 17

The method of Aspect 16, wherein the driving context is based on a location of the vehicle.

### Aspect 18

The method of any of Aspects 14-17, further comprising: determining a relationship between a first object in the set of objects and a second object in the set of objects; and encoding the relationship in the scene graph.

### Aspect 19

The method of Aspect 18, wherein the relationship comprises at least one of a distance between the first object and the second object, or an intent of the first object with respect to the second object.

### Aspect 20

The method of any of Aspects 18-19, further comprising: encoding the first object as a first node in the scene graph; encoding the second object as a second node in the scene graph; and encoding the relationship as an edge between the first node and the second node.

### Aspect 21

The method of any of Aspects 14-20, wherein the obtained set of multimodal data includes at least one of an image, a light detection and ranging (LIDAR) data, or radio detection and ranging (RADAR) data.

### Aspect 22

The method of any of Aspects 14-21, further comprising: detecting a second set of objects in the environment based on an obtained second set of multimodal data; and updating the scene graph based on the second set of objects.

### Aspect 23

A method for data collection, comprising: receiving a description of a scenario of interest, wherein the description comprises a textual description of the scenario of interest; parsing the description of the scenario of interest to generate a query scene graph based on the description of the scenario of interest; outputting the description of the scenario of interest for transmission to a vehicle; and outputting the query scene graph for transmission to the vehicle.

### Aspect 24

The method of Aspect 23, further comprising: receiving a scene graph matching the query scene graph from the vehicle; and storing the scene graph in a dataset.

### Aspect 25

The method of Aspect 24, wherein the description of a scenario of interest is generated based on scenarios which are underrepresented in the dataset.

### Aspect 26

The method of any of Aspects 23-25, wherein the description of the scenario includes a first object, a second object, and a relationship between the first object and second object, and further comprising: encoding the first object as a first node in the query scene graph; encoding the second object as a second node in the query scene graph; and encoding the relationship as an edge between the first node and the second node.

### Aspect 27

A non-transitory computer-readable medium having stored thereon instructions that, when executed by at least one processor, cause the at least one processor to perform operations according to any of Aspects 14-22.

### Aspect 28

A non-transitory computer-readable medium having stored thereon instructions that, when executed by at least one processor, cause the at least one processor to perform operations according to any of Aspects 23-26.

### Aspect 34

An apparatus for data collection comprising one or more means for performing operations according to any of Aspects 14-22.

### Aspect 35

An apparatus for data collection comprising one or more means for performing operations according to any of Aspects 23-26.

What is claimed is:

1. An apparatus for data collection, comprising:
at least one memory; and
at least one processor coupled to the at least one memory and configured to:
detect a set of objects in an environment based on an obtained set of multimodal data from a plurality of sensors;
generate a scene graph based on the set of objects;
receive a query scene graph, wherein the query scene graph describes a scenario of interest;
match the scene graph with the query scene graph; and
output the scene graph based on a successful match between the scene graph and the query scene graph.

2. The apparatus of claim 1, wherein the at least one processor is configured to:
receive a first description of a first scenario of interest, wherein the first description comprises a textual description of the first scenario of interest; and
output the textual description of the first scenario of interest.

3. The apparatus of claim 2, wherein the at least one processor is configured to:
receive a second description of a second scenario of interest;
determine a driving context of the apparatus; and
determine to output the second description of the second scenario of interest instead of the first description of the first scenario of interest based on the driving context of the apparatus.

4. The apparatus of claim 3, wherein the driving context is based on a location of the apparatus.

5. The apparatus of claim 1, wherein the at least one processor is configured to:
determine a relationship between a first object in the set of objects and a second object in the set of objects; and
encode the relationship in the scene graph.

6. The apparatus of claim 5, wherein the relationship comprises at least one of a distance between the first object and the second object, or an intent of the first object with respect to the second object.

7. The apparatus of claim 5, wherein the at least one processor is configured to:
encode the first object as a first node in the scene graph;
encode the second object as a second node in the scene graph; and
encode the relationship as an edge between the first node and the second node.

8. The apparatus of claim 1, wherein the obtained set of multimodal data includes at least one of an image, a light detection and ranging (LIDAR) data, or radio detection and ranging (RADAR) data.

9. The apparatus of claim 1, wherein the at least one processor is configured to:
detect a second set of objects in the environment based on an obtained second set of multimodal data; and
update the scene graph based on the second set of objects.

10. An apparatus for data collection, comprising:
at least one memory; and
at least one processor coupled to the at least one memory and configured to:
receive a description of a scenario of interest, wherein the description comprises a textual description of the scenario of interest;
parse the description of the scenario of interest to generate a query scene graph based on the description of the scenario of interest;
output the description of the scenario of interest for transmission to a vehicle; and
output the query scene graph for transmission to the vehicle.

11. The apparatus of claim 10, wherein the at least one processor is further configured to:
receive a scene graph matching the query scene graph from the vehicle; and
store the scene graph in a dataset.

12. The apparatus of claim 11, wherein the description of a scenario of interest is generated based on scenarios which are underrepresented in the dataset.

13. The apparatus of claim 10, wherein the description of the scenario includes a first object, a second object, and a relationship between the first object and second object, and wherein the at least one processor is further configured to:
encode the first object as a first node in the query scene graph;
encode the second object as a second node in the query scene graph; and
encode the relationship as an edge between the first node and the second node.

14. A method for data collection, comprising:
detecting a set of objects in an environment based on an obtained set of multimodal data from a plurality of sensors;
generating a scene graph based on the set of objects;
receiving a query scene graph, wherein the query scene graph describes a scenario of interest;
matching the scene graph with the query scene graph; and
outputting the scene graph based on a successful match between the scene graph and the query scene graph.

15. The method of claim 14, further comprising:
receiving a first description of a first scenario of interest, wherein the first description comprises a textual description of the first scenario of interest; and
outputting the textual description of the first scenario of interest.

16. The method of claim 15, further comprising:
receiving a second description of a second scenario of interest;
determining a driving context of a vehicle; and
determining to output the second description of the second scenario of interest instead of the first description of the first scenario of interest based on the driving context of the vehicle.

17. The method of claim 16, wherein the driving context is based on a location of the vehicle.

18. The method of claim 14, further comprising:
determining a relationship between a first object in the set of objects and a second object in the set of objects; and
encoding the relationship in the scene graph.

19. The method of claim 18, wherein the relationship comprises at least one of a distance between the first object and the second object, or an intent of the first object with respect to the second object.

20. The method of claim 18, further comprising:
encoding the first object as a first node in the scene graph;
encoding the second object as a second node in the scene graph; and
encoding the relationship as an edge between the first node and the second node.
